(19) United States
(12) Patent Application Publication
(10) Pub. No.: US 2015/0348333 A1
(43) Pub. Date: Dec. 3, 2015

(54) Multi-Mode Communication Parking Meter System and Method

(71) Applicant: POM Incorporated, Russellville, AR (US)

(72) Inventor: Seth Ward, III, Russellville, AR (US)

(73) Assignee: POM Incorporated, Russellville, AR (US)

(21) Appl. No.: 14/289,423

(22) Filed: May 28, 2014

(51) Int. Cl. G07B 15/02

(52) U.S. Cl. CPC G07B 15/02; H04W 4/008

(57) ABSTRACT

A parking meter is provided in the present disclosure. The parking meter comprises a short-range communication component, a long-range communication component, and a processor. The short-range communication component is configured to receive parking payment information from one or more other parking meters. The long-range communication component is configured to transmit the parking payment information. The processor is configured to participate in a procedure whereby the long-range communication component is configured to operate in at least one of an on mode, a low-power mode, or an off mode.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

When paying a fee for the use of a parking space associated with a traditional parking meter, a customer may deposit coins into the meter. In an advance over the traditional parking meter, a customer may pay for parking by transferring payment data to a parking meter rather than inserting physical money. For example, the customer may transfer account information into a parking meter by swiping a credit or debit card, inserting a credit or debit card, or otherwise bringing a credit or debit card into the proximity of a card reader on the parking meter. Alternatively, a mobile phone or a similar communication device may contain information that may be used for payment, and a customer may be able to wirelessly transfer the payment information from the device to the parking meter. In other cases, a customer may be able to transfer payment data to a parking meter in other ways.

In some cases, a traditional parking meter that accepts coins may be fitted with a data reception component that can accept a transfer of payment data, and such a parking meter could thus accept either coins or a data transfer. In other cases, only such a data reception component may be present at or near a parking space. In the latter cases, some type of identifier for a parking space may be present, such as a freestanding sign with an identification number for the parking space, a placard or other identifying sign on the ground or on a wall near the parking space, or an identifier painted on the ground in the parking space. Also in the latter cases, a single data reception component may accept payment for a plurality of parking spaces. When such a multi-space parking meter is present, a customer may enter both payment data and an identifier for the parking space. Any traditional parking meter with a data reception component or any data reception component associated with one or more parking spaces will be referred to herein as a parking meter.

### SUMMARY

In an embodiment, a parking meter is provided. The parking meter comprises a short-range communication component, a long-range communication component, and a processor. The short-range communication component is configured to receive parking payment information from one or more other parking meters. The long-range communication component is configured to transmit the parking payment information. The processor is configured to participate in a procedure whereby the long-range communication component is configured to operate in at least one of an on mode, a low-power mode, or an off mode.

In another embodiment, a mesh network is provided. The mesh network comprises a plurality of parking meters, wherein each of the parking meters includes a short-range communication component configured to transmit and receive data via the mesh network, and wherein more than one of the parking meters includes a long-range communication component, and wherein less than all of the long-range communication components operate in an on mode.

In another embodiment, a method for communication by a parking meter is provided. The method comprises receiving, by a first short-range communication component in a first parking meter, from a second short-range communication component in a second parking meter, parking payment information received by the second parking meter. The method further comprises transmitting, by a first long-range communication component in the first parking meter, the parking payment information. The first long-range communication component has been selected to operate in an on mode and a second long-range communication component in the second parking meter has been selected to operate in one of a low-power mode or an off mode.

In another embodiment, a parking meter is provided. The parking meter comprises a short-range communication component, a long-range communication component, and a processor. The short-range communication component is configured to receive parking payment information from one or more other parking meters. The long-range communication component is configured to transmit the parking payment information. The processor is configured to participate in a procedure whereby the long-range communication component is selected to operate in at least one of an on mode, a low-power mode, or an off mode based on one of the signal strength or battery level of the parking meter relative to the one or more other parking meters.

In another embodiment, a parking meter is provided. The parking meter comprises a short-range communication component configured to receive parking payment information from one or more other parking meters and a long-range communication component configured to transmit the parking payment information to a payment processing center.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates a plurality of parking meters configured to communicate via a mesh network according to an embodiment of the disclosure.

FIG. 2 illustrates a method for communication by a parking meter according to an embodiment of the disclosure.

FIG. 3 is a diagram of a system that is operable for some of the various embodiments of the disclosure.

### DETAILED DESCRIPTION

It should be understood at the outset that although an illustrative implementation of one embodiment of the disclosure is illustrated below, the system may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents.

A parking meter that can accept payment via a transfer of data may be equipped with a component that can transmit the data over a long distance via a wireless telecommunication network to a payment processing center or a similar location. For example, the parking meter may transmit the data via a third generation (3G) cell modem, via a Long Term Evolution (LTE) communication component, or via any similar component capable of interacting with a wireless telecommunication network. Any such component will be referred to herein as a long-range communication component.

The entity that receives the payment data may approve a credit card transaction or otherwise process the payment data. That entity may then transmit approval information, information for display on the parking meter, and/or other information to the long-range communication component via the wireless telecommunication network.

A long-range communication component may be capable of operating in one of a plurality of different modes, each of which may consume a different level of electric power. In the highest power mode, a long-range communication component maintains an active connection with a wireless telecommunication network and may transfer data to the wireless telecommunication network as soon as the data becomes available to the long-range communication component. This highest power mode may be referred to hereinafter as the “on” mode. In the lowest power mode, a long-range communication component maintains no connection with or presence on a wireless telecommunication network and consumes little or no electric power other than the minimal amount needed to be reawakened from its lowest-power state. The process of the long-range communication component reawakening and establishing a connection with a wireless telecommunication network may take from a few seconds to more than one minute. This lowest power mode may be referred to hereinafter as the “off” mode. Between the on mode and the off mode may be one or more intermediate states in which a long-range communication component saves power by maintaining less active functionality than a long-range communication component in the on mode but more active functionality than a long-range communication component in the off mode. A long-range communication component in any of these intermediate states may establish a connection with a wireless telecommunication network more quickly than a long-range communication component in the off mode but may use less power than a long-range communication component in the on mode. Any such intermediate state may be referred to hereinafter as a low-power mode. For brevity herein, a parking meter with a long-range communication component operating in the on mode may be referred to hereinafter as a parking meter operating in the on mode, a parking meter with a long-range communication component operating in the low-power mode may be referred to hereinafter as a parking meter operating in the low-power mode, and a parking meter with a long-range communication component operating in the off mode may be referred to hereinafter as a parking meter operating in the off mode.

To save power, a parking meter may be operated in the low-power mode or the off mode until a customer initiates a transaction on the parking meter, at which time the parking meter may attempt to enter the on mode. However, the length of time needed to establish an active connection between a wireless telecommunication network and a parking meter in the low-power mode or the off mode may be greater than the time a customer is willing to wait for a parking payment transaction to occur. Customers may become impatient waiting for such a parking meter to connect to the wireless telecommunication network and may tend to choose another parking option. If customers avoid using parking meters that take an excessive amount of time to process payment transactions, the municipality or other entity that operates the parking meters may lose revenue. Thus, it may be preferable for a parking meter to remain in the on mode at all times so that data can be transferred from the parking meter to the wireless telecommunication network with minimal delay.

However, operating a battery-powered parking meter in the on mode at all times may consume a great deal of battery power. Not only may energy be wasted in such a scenario, but an entity operating a large number of parking meters may spend a great deal of effort and money replacing depleted batteries. Therefore, it may be preferable to operate a parking meter in the low-power mode or the off mode for at least a portion of the parking meter's operating time.

In an embodiment, a plurality of parking meters may form a network with one another that operates wirelessly over relatively short distances. All of the parking meters may play equivalent roles in the network, and there may be no central server or other control component overseeing the network. Such a network may be referred to as a mesh network, an ad hoc network, a peer-to-peer network, or some other name, but will hereinafter be referred to as a mesh network. Communication among the parking meters in the mesh network may occur via various technologies, such as ZigBee, Bluetooth, WiFi, or similar short-range communication technologies. The communication may occur over the industrial, scientific and medical (ISM) radio band or some other portion of the radio spectrum. Any component capable of communicating via such technologies and such radio frequencies will be referred to hereinafter as a short-range communication component.

In an embodiment, each parking meter in a plurality of parking meters is equipped with a short-range communication component. In some cases, all of the parking meters are also equipped with a long-range communication component. In other cases, less than all, but more than one, of the parking meters are equipped with a long-range communication component. In an embodiment, less than all of the long-range communication components remain in the on mode at any one time. In particular, only one parking meter that is engaged in a mesh network with at least one other parking meter may be operated in the on mode at a given time, and the other parking meters in the mesh network may be operated in the low-power mode or the off mode at that time. The parking meters in the low-power mode or the off mode may communicate via their short-range communication components and the mesh network to transmit any parking payment information they have received to the parking meter that is in the on mode. Each parking meter in the low-power mode or the off mode may transmit its parking payment information directly to the parking meter in the on mode. Alternatively, a parking meter in the low-power mode or the off mode may transmit its parking payment information to another parking meter in the low-power mode or the off mode. The parking payment information may continue to be relayed from parking meter to parking meter until the information reaches the parking meter in the on mode.

The parking meter in the on mode may then use its long-range communication component to communicate the payment data for all of the parking meters in the mesh network to a payment processing center or a similar site via a wireless telecommunication network. The parking meter in the on mode may then receive data in return from the payment processing center or other location via the wireless telecommunication network and may transmit all or part of that data to the parking meters in the low-power mode or the off mode via the mesh network. For example, the parking meter in the on mode may receive the length of parking time purchased on one of the parking meters in the low-power mode or the off mode and may transmit that information to the appropriate parking meter for display on that parking meter. Hereinafter, a parking meter operating in this manner to transmit data via its long-range communication component on behalf of other parking meters that are operating in the low-power mode or the off mode may be referred to as a gateway parking meter. Operating a portion of the parking meters in a plurality of parking meters in the low-power mode or the off mode and at least one of the parking meters as a gateway parking meter in this manner may greatly reduce the total battery power consumption in the plurality of parking meters.

The determination of which parking meter in a plurality of parking meters is to act as the gateway parking meter may be made in several ways. In the following discussion of such a determination, it may be assumed that only one parking meter in a plurality of parking meters is selected to operate as the gateway parking meter, but it should be understood that in some cases more than one parking meter may be selected to operate as the gateway parking meter.

In an embodiment, one parking meter in a plurality of parking meters may be selected on a time basis to operate as the gateway parking meter. That is, for a predefined period of time, a first parking meter may operate as the gateway parking meter and all other parking meters in a mesh network with the first parking meter may operate in the low-power mode or the off mode. When the parking meters in the low-power mode or the off mode receive payment data, those parking meters may transmit the payment data to the first parking meter via the mesh network, and the first parking meter may substantially immediately transmit the payment data to a wireless telecommunication network via its long-range communication component. After the predefined period of time has expired, the first parking meter may enter the low-power mode or the off mode, and a second parking meter may enter the on mode for the predefined period of time, thereby becoming the next gateway parking meter. The selection of one of the parking meters to be the parking meter that remains in the on mode, receives payment data from the other parking meters, and transmits the payment data via its long-range communication component may continue to rotate in this manner through the plurality of parking meters. The predefined length of time may be one day, one hour, several hours, or any other interval deemed appropriate.

In other embodiments, one parking meter in a plurality of parking meters may be selected to operate as the gateway parking meter based on information the parking meters receive by polling one another regarding one or more operational parameters of the parking meters. That is, each parking meter may send each of the other parking meters information about the status of more or more parameters pertaining to that parking meter. Each parking meter may also receive such information from every other parking meter. The parking meters may then perform a procedure whereby that information is used to select at least one parking meter to operate as the gateway parking meter and select the other parking meters to operate in the low-power mode or the off mode. The parameters that are polled and on which such selections are based may include available battery power on the parking meters, available solar power on the parking meters, the number of transactions occurring on the parking meters, and/or the strengths of the radio signals being received by the parking meters.

In an embodiment, a parking meter may be selected to operate as the gateway parking meter based on available battery power. Each parking meter in a plurality of parking meters may be capable of transmitting information about its battery level to each of the other parking meters via a mesh network in which the parking meters are engaged. Each of the parking meters may also have a processor capable of determining which of the parking meters has the greatest available battery power. The processors may cause the parking meter with the most battery power to operate in the on mode and the other parking meters to operate in the low-power mode or the off mode. The parking meters may continue to exchange battery level information, and when the battery power in the parking meter in the on mode drops below the battery power in one of the parking meters in the low-power mode or the off mode, the parking meter in the low-power mode or the off mode that has the highest battery power may become the parking meter that operates in the on mode, and the parking meter that was previously in the on mode may enter the low-power mode or the off mode. The gateway parking meter may continue to change in this manner as the available battery power in the parking meters changes.

In another embodiment, a parking meter may be selected based on available solar power to operate as the gateway parking meter. One or more of the parking meters in a plurality of parking meters may include a solar panel capable of providing electric power directly to the electronic components of its associated parking meter and/or capable of recharging the battery in its associated parking meter. Varying meteorological conditions and/or the different locations of the parking meters may cause one solar panel to produce more electricity at a given time than another solar panel. In an embodiment, a plurality of parking meters in a mesh network may exchange information regarding the amount of electricity each of their solar panels is currently producing. The processors in the parking meters may then cause the parking meter with the solar panel that is producing the most electricity to operate in the on mode and the other parking meters to operate in the low-power mode or the off mode. If meteorological conditions change and another solar panel begins producing more electricity, the other parking meter may be selected to operate as the gateway parking meter.

In another embodiment, a parking meter may be selected to operate as the gateway parking meter based on the number of transactions currently occurring on that parking meter. Due to location or other factors, some parking meters in a plurality of parking meters may process more transactions than others. A parking meter that is processing fewer transactions may have more availability to communicate with a wireless telecommunication network than a parking meter that is processing more transactions. In an embodiment, a plurality of parking meters in a mesh network may exchange information regarding the number of transactions that each parking meter is currently processing. The processors in the parking meters may then cause the parking meter that is processing the fewest transactions to operate in the on mode and the other parking meters to operate in the low-power mode or the off mode. If transaction loads change, another parking meter with a smaller load may be selected to operate as the gateway parking meter.

In another embodiment, a parking meter may be selected to operate as the gateway parking meter based on the strengths of the radio signals being received by the parking meters. Due to meteorological conditions, physical obstructions, and other factors, the long-range communication components in some of the parking meters may receive stronger signals from a wireless telecommunication network than the long-range communication components in other parking meters. It may be preferable to have a parking meter with a strong radio signal communicate with the wireless telecommunication network. In an embodiment, the parking meters may exchange information about the signal strengths that each parking meter is currently receiving, and the processors in the parking meters may then cause the parking meter receiving the strongest signal with regard to its long-range communication component to operate in the on mode and the other parking meters to operate in the low-power mode or the off mode. If signal strengths change, another parking meter with a stronger signal may be selected to operate as the gateway parking meter.

In addition to the battery power savings, the overall reliability of a plurality of parking meters may be improved by using differences in signal strength to determine which of the parking meters is to operate as the gateway parking meter and which of the parking meters are to operate in the low-power mode or the off mode. That is, one or more parking meters in a group of parking meters in a mesh network may typically receive weak radio signals regarding their long-range communication components due to their locations or other factors. In an embodiment, such parking meters may not use their long-range communication components and may instead transmit their data via their short-range communication components to another parking meter in the mesh network that typically receives a stronger signal. The parking meter with the stronger signal may then act as a gateway parking meter and transmit that data via its long-range communication component on behalf of the parking meters with the weaker signals. In this way, difficulties in receiving an adequate signal caused by tall buildings and other obstructions may be avoided.

Furthermore, the use in combination of short-range communication components and long-range communication components in such a manner may allow parking meters with wireless communication capabilities to be installed in locations where they may not be feasible otherwise. For example, the radio signals in a location may be so weak that a parking meter with wireless communication capabilities installed in that location may not function properly. Previously in such cases, either a traditional mechanical parking meter may have been installed or no parking meter at all may have been installed. In an embodiment, a parking meter as disclosed herein may be installed in such a location and may use its short-range communication component to transmit parking payment information to another parking meter that receives a sufficiently strong radio signal. The parking meter with the stronger signal may then act as a gateway parking meter and transmit the parking payment information via its long-range communication component on behalf of the parking meter with the inadequate signal. Alternatively, the parking meter with the inadequate signal may transmit the information to another parking meter with an inadequate signal, and the information may continue to be relayed from parking meter to parking meter until the information reaches a parking meter with a strong enough signal to transmit the information via its long-range communication component. In such embodiments, the polling procedure described above for determining the relative signal strengths for a plurality of parking meters may not be necessary since it may be known prior to the installation of the parking meters which parking meters are likely to receive an inadequate radio signal.

In some embodiments, a combination of one or more of the above factors may be used to determine which parking meter in a plurality of parking meters is selected to operate as the gateway parking meter. For example, a combination of battery level and solar panel electricity production level may be used to determine which parking meter is to operate as the gateway parking meter. As another example, a parking meter may be selected to operate as the gateway parking meter on a time basis, but that selection may be overridden if the strength of the signal received by that parking meter drops below a threshold. In other embodiments, other combinations of the above factors may be used.

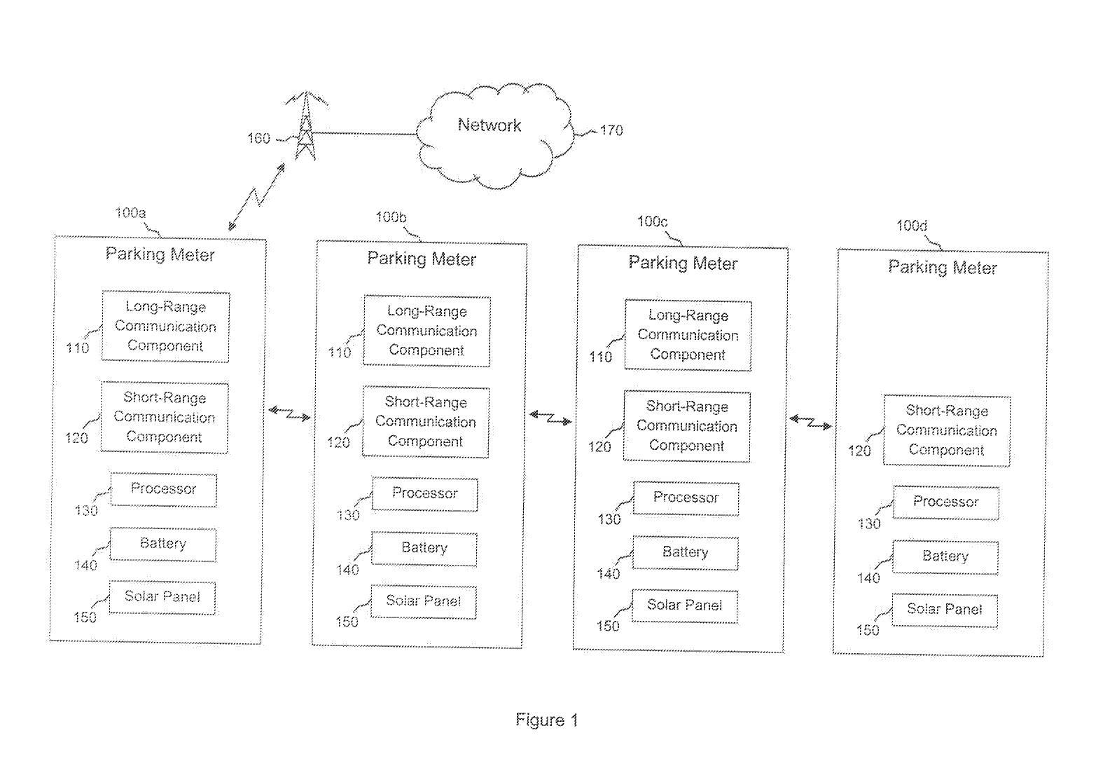

FIG. 1 illustrates an embodiment of a system that includes a plurality of parking meters 100 configured to operate in a mesh network. While four parking meters 100 are shown, other numbers of parking meters 100 greater than one could be present. More than one of the parking meters 100 includes a long-range communication component 110, as described above. In this example, parking meter 100a, parking meter 100b, and parking meter 100c do include the long-range communication component 110, and parking meter 100d does not include the long-range communication component 110. In other examples, other numbers of parking meters 100 may not include the long-range communication component 110, or all of the parking meters 100 may include the long-range communication component 110.

Each of the parking meters 100 also includes a short-range communication component 120, as described above. In some embodiments, the long-range communication component 110 and the short-range communication component 120 may reside on the same circuit board within one of the parking meters 100. In other embodiments, the long-range communication component 110 and the short-range communication component 120 may reside on different circuit boards within one of the parking meters 100. The short-range communication components 120 are capable of wirelessly communicating with one another via one or more of the protocols described above. Communication via the short-range communication components 120 may allow the parking meters 100 to form a mesh network with one another. The mesh network may have a ring topology, where each parking meter 100 communicates only with its neighbors on each side and passes data from a neighbor on one side to a neighbor on the other side. Alternatively, the mesh network may have a one-to-one topology, where each parking meter 100 communicates with all of the other parking meters 100. Alternatively, the parking meters 100 may form a mesh or other network in some other manner.

The short-range communication components 120 may remain active at all times in order to maintain the mesh network. The battery power consumed by one of the short-range communication components 120 while active may be less than the battery power consumed by one of the long-range communication components 110 in the on mode. Thus, the use of the short-range communication components 120 to allow at least a portion of the long-range communication components 110 to operate in the low-power mode or the off mode may reduce overall battery power consumption in the plurality of parking meters 100.

Each of the parking meters 100 also includes a processor 130. Each processor 130 may be configured to receive information from its associated short-range communication component 120 regarding the battery levels, solar panel input levels, transaction loads, and/or signal strengths of the other parking meters 100, as described above. Each processor 130 may then use such information to determine which of the parking meters 100 is to operate in the on mode and which of the parking meters 100 is to operate in the low-power mode or the off mode. Each processor 130 may also be configured to manage the time-based designation of which of the parking meters 100 is to operate in the on mode. In addition, each processor 130 may be configured to perform tasks related to the management of the mesh network.

Each of the parking meters 100 also includes one or more batteries 140 to provide electrical power to their associated parking meters 100. One or more of the parking meters 100 may also include a solar panel 150 that is capable of providing electrical power directly to the electronic components of its associated parking meter 100 and/or recharging its associated battery 140. Other components that may be present in the parking meters 100, such as a data or time display, user input mechanisms, cash or coin payment components, electronic payment components such as credit card readers, charges for parking, and so on, are not shown.

As an example of the operation of the battery 140 and the solar panel 150, one or more of the parking meters 100 may include a lithium ion battery, a lithium thionyl battery, and the solar panel 150. The lithium ion battery and the lithium thionyl battery may collectively comprise the component referred to in FIG. 1 as the battery 140. If the solar panel 150 is capable of producing enough electricity to power its associated parking meter 100 without any battery power, the solar panel 150 alone may provide power to the parking meter 100. If the solar panel 150 is not capable of producing enough electricity to power its associated parking meter 100, the solar panel 150 and the lithium ion battery may combine to provide power to the parking meter 100. If the solar panel 150 is capable of producing more than enough electricity to power its associated parking meter 100, the solar panel 150 may use the excess electricity to recharge the lithium ion battery. If the combination of the solar panel 150 and the lithium ion battery is not capable of producing enough electricity to power their associated parking meter 100, the lithium thionyl battery may provide power to the parking meter 100. The solar panel 150 may recharge the lithium ion battery while the lithium thionyl battery is in use. In other examples, other combinations of battery power and solar power may be used.

In the example of FIG. 1, parking meter 100a has been selected to operate as the gateway parking meter, and parking meter 100b, parking meter 100c, and parking meter 100d have been selected to operate in the low-power mode or the off mode. The selection may have been based on one or more of the factors described above. In other examples, parking meter 100b or parking meter 100c could have been selected to operate as the gateway parking meter. Parking meter 100d would not be selected to operate as the gateway parking meter since it does not have a long-range communication component 110.

When parking meter 100b, parking meter 100c, or parking meter 100d receives payment data, that parking meter 100 may send the payment data via its short-range communication component 120 and the mesh network to parking meter 100a. Parking meter 100a may substantially immediately transmit the payment data via its long-range communication component 110 to a base station 160 or a similar component configured to communicate wirelessly with the parking meters 100. The base station 160 may then communicate with a wireless and/or wired telecommunication network 170, via which data transmissions to and from a payment processing center or a similar location may occur. The payment processing center or other location may return data via the wireless telecommunication network 170 and the base station 160 to parking meter 100a. For example, an approval of payment may be returned, and then the length of parking time purchased may be displayed on the parking meter 100 for which the time was purchased. Parking meter 100a may then transmit the received data via its short-range communication component 120 and the mesh network to one or more of the other parking meters 100 or may retain the data if the data applies to itself.

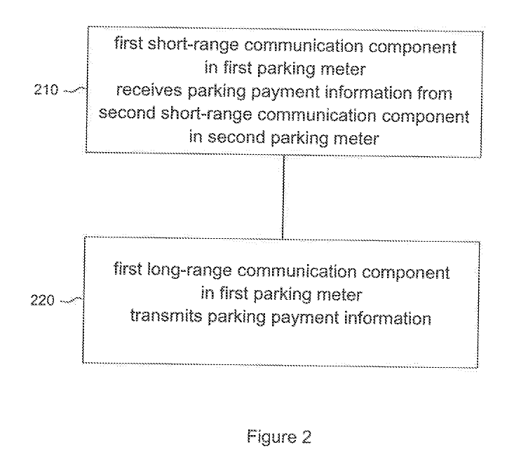

FIG. 2 illustrates an embodiment of method for communication by a parking meter. At block 210, a first short-range communication component in a first parking meter receives, from a second short-range communication component in a second parking meter, parking payment information received by the second parking meter. At block 220, a first long-range communication component in the first parking meter transmits the parking payment information. The first long-range communication component has been selected to operate in an on mode and a second long-range communication component in the second parking meter has been selected to operate in either a low-power mode or an off mode.

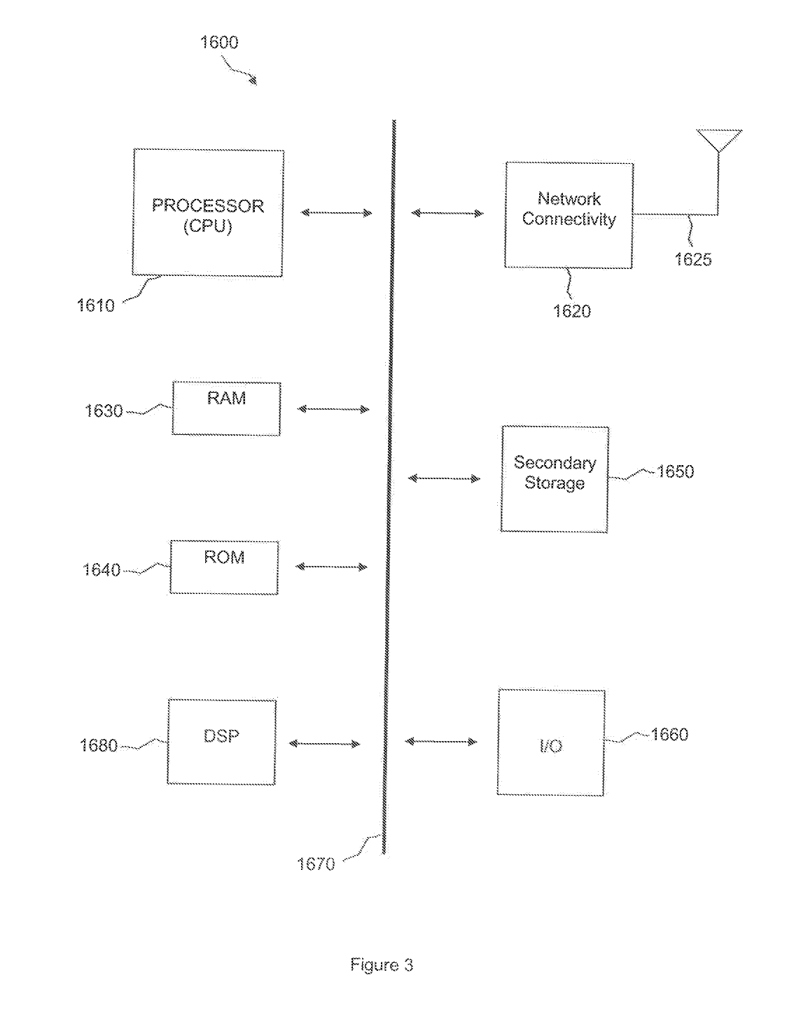

FIG. 3 illustrates an example of a system 1600 that includes a processing component 1610 suitable for implementing one or more embodiments disclosed herein. One or more of the components of the system 1600 may be present in the parking meters 100. The processing component 1610 may be substantially similar to the processor 130 of FIG. 1. In addition to the processor 1610 (which may be referred to as a central processor unit or CPU), the system 1600 might include network connectivity devices 1620, random access memory (RAM) 1630, read only memory (ROM) 1640, secondary storage 1650, and input/output (I/O) devices 1660. These components might communicate with one another via a bus 1670. In some cases, some of these components may not be present or may be combined in various combinations with one another or with other components not shown. These components might be located in a single physical entity or in more than one physical entity. Any actions described herein as being taken by the processor 1610 might be taken by the processor 1610 alone or by the processor 1610 in conjunction with one or more components shown or not shown in the drawing, such as a digital signal processor (DSP) 1680. Although the DSP 1680 is shown as a separate component, the DSP 1680 might be incorporated into the processor 1610.

The processor 1610 executes instructions, codes, computer programs, or scripts that it might access from the network connectivity devices 1620, RAM 1630, ROM 1640, or secondary storage 1650 (which might include various disk-based systems such as hard disk, floppy disk, or optical disk). While only one CPU 1610 is shown, multiple processors may be present. Thus, while instructions may be discussed as being executed by a processor, the instructions may be executed simultaneously, serially, or otherwise by one or multiple processors. The processor 1610 may be implemented as one or more CPU chips.

The network connectivity devices 1620 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1620 may enable the processor 1610 to communicate with the Internet or one or more telecommunications networks or other networks from which the processor 1610 might receive information or to which the processor 1610 might output information. The network connectivity devices 1620 might also include one or more transceiver components 1625 capable of transmitting and/or receiving data wirelessly.

The RAM 1630 might be used to store volatile data and perhaps to store instructions that are executed by the processor 1610. The ROM 1640 is a non-volatile memory device that typically has a smaller memory capacity than the memory capacity of the secondary storage 1650. ROM 1640 might be used to store instructions and perhaps data that are read during execution of the instructions. Access to both RAM 1630 and ROM 1640 is typically faster than to secondary storage 1650. The secondary storage 1650 is typically comprised of one or more disk drives or tape drives and might be used for non-volatile storage of data or as an over-flow data storage device if RAM 1630 is not large enough to hold all working data. Secondary storage 1650 may be used to store programs that are loaded into RAM 1630 when such programs are selected for execution.

The I/O devices 1660 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1625 might be considered to be a component of the I/O devices 1660 instead of or in addition to being a component of the network connectivity devices 1620.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed:

1. A parking meter comprising:
a short-range communication component configured to receive parking payment information from one or more other parking meters;
a long-range communication component configured to transmit the parking payment information; and
a processor configured to participate in a procedure whereby the long-range communication component is configured to operate in at least one of an on mode, a low-power mode, or an off mode.

2. The parking meter of claim 1, wherein the long-range communication component is selected to operate in the on mode based on at least one of:
a rotating basis, wherein the long-range communication component operates in the on mode for a predefined length of time and ceases to operate in the on mode upon expiration of the predefined length of time, and wherein a second long-range communication component in a second parking meter begins to operate in the on mode upon expiration of the predefined length of time;
available power in a battery in the parking meter and a battery in at least one other parking meter, wherein the battery in the parking meter has more available power than the battery in the at least one other parking meter;
available power provided by a solar panel on the parking meter and a solar panel on at least one other parking meter, wherein the solar panel on the parking meter provides more power than the solar panel on the at least one other parking meter;
a number of transactions occurring on the parking meter and on at least one other parking meter, wherein fewer transactions are occurring on the parking meter than on the at least one other parking meter; and
a strength of a radio signal received by the long-range communication component and a strength of a radio signal received by a second long-range communication component in a second parking meter, wherein the strength of the radio signal received by the long-range communication component is greater than the strength of the radio signal received by the second long-range communication component.

3. The parking meter of claim 1, wherein the short-range communication component transmits and receives data via at least one of:
a ZigBee-based protocol;
a Bluetooth-based protocol; and
a WiFi-based protocol.

4. The parking meter of claim 1, wherein the short-range communication component transmits and receives data via the industrial, scientific and medical (ISM) radio band.

5. The parking meter of claim 1, wherein the long-range communication component transmits the parking payment information to a payment processing center and receives data in return from the payment processing center, and wherein the short-range communication component transmits at least a portion of the data to at least one other parking meter.

6. A mesh network comprising:
a plurality of parking meters, wherein each of the parking meters includes a short-range communication component configured to transmit and receive data via the mesh network, and wherein more than one of the parking meters includes a long-range communication component, and wherein less than all of the long-range communication components operate in an on mode or low-power mode.

7. The mesh network of claim 6, wherein parking meters with long-range communication components not operating in the on mode transmit parking payment information via the short-range communication component to at least one parking meter with a long-range communication component operating in the on mode, and wherein a parking meter that receives the parking payment information transmits the parking payment information via the long-range communication component in the on mode.

8. The mesh network of claim 6, wherein at least one of the long-range communication components is selected to operate in the on mode or low-power mode based on at least one of:
a rotating basis, wherein a first long-range communication component operates in the on mode or low-power mode for a predefined length of time and ceases to operate in the on mode or low-power mode upon expiration of the predefined length of time, and wherein a second long-range communication component begins to operate in the on mode or low-power mode upon expiration of the predefined length of time;
available power in a battery in each of the parking meters, wherein the long-range communication component in at least one of the parking meters with a battery with more available power than a battery in another parking meter is selected to operate in the on mode or low-power mode;
available power provided by a solar panel on a plurality of the parking meters, wherein the long-range communication component in at least one of the parking meters with a solar panel providing more power than another solar panel is selected to operate in the on mode or low-power mode;
a number of transactions occurring on the parking meters, wherein the long-range communication component in at least one of the parking meters on which fewer transactions are occurring than on another parking meter is selected to operate in the on mode or low-power mode; and
strengths of radio signals received by the long-range communication components, wherein a long-range communication component that is receiving a stronger radio signal than another long-range communication component is selected to operate in the on mode or low-power mode.

9. The mesh network of claim 6, wherein the short-range communication component transmits and receives data via at least one of:
a ZigBee-based protocol;
a Bluetooth-based protocol; and
a WiFi-based protocol.

10. The mesh network of claim 6, wherein the short-range communication component transmits and receives data via the industrial, scientific and medical (ISM) radio band.

11. The mesh network of claim 7, wherein the long-range communication component transmits the parking payment information to a payment processing center and receives data in return from the payment processing center, and wherein the short-range communication component present in the parking meter in which the long-range communication component is present transmits at least a portion of the data to at least one other parking meter in the mesh network.

12. A method for communication by a parking meter, the method comprising:
receiving, by a first short-range communication component in a first parking meter, from a second short-range communication component in a second parking meter, parking payment information received by the second parking meter; and
transmitting, by a first long-range communication component in the first parking meter, the parking payment information,
wherein the first long-range communication component has been selected to operate in an on mode and a second long-range communication component in the second parking meter has been selected to operate in one of a low-power mode or an off mode.

13. The method of claim 12, wherein the first long-range communication component is selected to operate in the on mode on a rotating basis, wherein the first long-range communication component operates in the on mode for a predefined length of time and ceases to operate in the on mode upon expiration of the predefined length of time, and wherein the second long-range communication component begins to operate in the on mode upon expiration of the predefined length of time.

14. The method of claim 12, wherein the first long-range communication component is selected to operate in the on mode based on a polling procedure whereby the first parking meter and the second parking meter exchange information regarding at least one operating parameter associated with the first parking meter and the second parking meter, and whereby the first long-range communication component is selected to operate in the on mode and the second long-range communication component is selected to operate in one of the low-power mode or the off mode based on a difference in a value of the at least one operating parameter.

15. The method of claim 14, wherein the at least one operating parameter is at least one of:
available power in a battery in the first parking meter and a battery in at least one other parking meter, wherein the battery in the first parking meter has more available power than the battery in the at least one other parking meter;
available power provided by a solar panel on the first parking meter and a solar panel on at least one other parking meter, wherein the solar panel on the first parking meter provides more power than the solar panel on the at least one other parking meter;
a number of transactions occurring on the first parking meter and on at least one other parking meter, wherein fewer transactions are occurring on the first parking meter than on the at least one other parking meter; and
a strength of a radio signal received by the first long-range communication component and a strength of a radio signal received by the second long-range communication component, wherein the strength of the radio signal received by the first long-range communication component is greater than the strength of the radio signal received by the second long-range communication component.

16. The method of claim 12, wherein the first short-range communication component transmits and receives data via at least one of:
a ZigBee-based protocol;
a Bluetooth-based protocol; and
a WiFi-based protocol.

17. The method of claim 12, wherein the first short-range communication component transmits and receives data via the industrial, scientific and medical (ISM) radio band.

18. The method of claim 12, wherein the first long-range communication component transmits the parking payment information to a payment processing center and receives data in return from the payment processing center, and wherein the first short-range communication component transmits at least a portion of the data to at least one other parking meter.

19. A parking meter comprising:
a short-range communication component configured to receive parking payment information from one or more other parking meters;
a long-range communication component configured to transmit the parking payment information; and
a processor configured to participate in a procedure whereby the long-range communication component is selected to operate in at least one of an on mode, a low-power mode, or an off mode based on one of the signal strength or battery level of the parking meter relative to the one or more other parking meters.

20. A parking meter comprising:
a short-range communication component configured to receive parking payment information from one or more other parking meters; and
a long-range communication component configured to transmit the parking payment information to a payment processing center.
